(19) United States
(12) Patent Application Publication
(10) Pub. No.: US 2007/0051759 A1
(43) Pub. Date: Mar. 8, 2007

(54) Drinking fluid carriers

(76) Inventor: Jon Grant, Surrey (GB)

Correspondence Address: BLANK ROME LLP, 600 NEW HAMPSHIRE AVENUE, N.W., WASHINGTON, DC, 20037, US

(21) Appl. No.: 10/565,729

(22) PCT Filed: Jul. 26, 2004
(86) PCT No.: PCT/GB04/03212

§ 371 Date: Jul. 27, 2006

(30) Foreign Application Priority Data
Jul. 25, 2003 (GB) 0317460.4

(51) Int. Cl. A45F 3/16; B67D 5/64; A45F 5/00

(52) U.S. Cl. 224/148.2; 222/175

(57) ABSTRACT

A portable flexible carrier for drinking fluid comprises a flexible fluid container (2) entirely encased within an outer separable cover (1) produced from a chemically hardened material which is impermeable to chemical toxins in liquid or gaseous form, biologically agents and radioactive particles. A tube (4) is connected to an opening of the flexible container (2) and extending beyond the confines of the cover (1) interior through which drinking fluid can be removed by suction from the container. The entire length of the tube (4) is encased within a conduit (5) produced from the chemically hardened material and an ON/OFF valve (6) in communication with the tube is provided to enable fluid to flow under suction from the carrier interior to the conduit. Means (19) is provided for selectively sealing the cover interior and its contents from the atmosphere.

This invention relates to flexible portable drinking fluid carriers and, more especially, to carriers having a flexible container encased within an outer cover produced from a flexible material able to resist contamination through contact with harmful toxins, biological agents and radioactive particles.

Portable drinking fluid carriers for inter alia military personnel are well known. These enable the user to have ready access to the fluid present In the container simply by operating an ON/OFF valve. Whereas these conventional carriers are impermeable, they are not able to prevent contamination of the fluid contents of the carrier in the event of chemical toxins, biological agents or radioactive particles being released into the atmosphere. In the event of such toxins, agents or particles being detected, the user has no access to drinking fluid until not only the fluid is replaced but also the carrier.

One object of this invention is to provide a flexible cover for a flexible drinking fluid carrier which prevents contamination of its fluid contents in the presence of chemical toxins, biological agents and radioactive particles.

In one aspect, the invention provides a portable flexible carrier for drinking fluid comprising a flexible fluid container entirely encased within an outer separable cover produced from a chemically hardened material which is impermeable to chemical toxins in liquid or gaseous form, biological agents and radioactive particles, a tube connected to an opening of the flexible container and extending beyond the confines of the cover Interior through which drinking fluid can be removed by suction from the container, a conduit produced from the chemically hardened material within which the entire length of the tube is encased, an ON/OFF valve in communication with the tube to enable fluid to flow under suction from the carrier interior to the conduit, and means for selectively sealing the cover interior and its contents from the atmosphere.

The chemically hardened material may comprise a fabric support covered by a protective complex which acts as a barrier to chemical toxins in liquid or gaseous form, biological agents and radioactive particles. One typical chemically hardened material is that marketed as 3TOX (trade mark) which is marketed by Paul Boye. In this particular material, the fabric support comprises an unwoven sheet.

The carrier may include shoulder straps to enable it to be carried on the back of the user. The cover may include a selectively sealable pouch and a sealable flap which is able to overlie the sealed end of the pouch. Sealing may be achieved through the use of strips of Velcro (Registered Trade Mark).

The invention will now be described, by way of example only, with reference to the accompanying drawing in which:

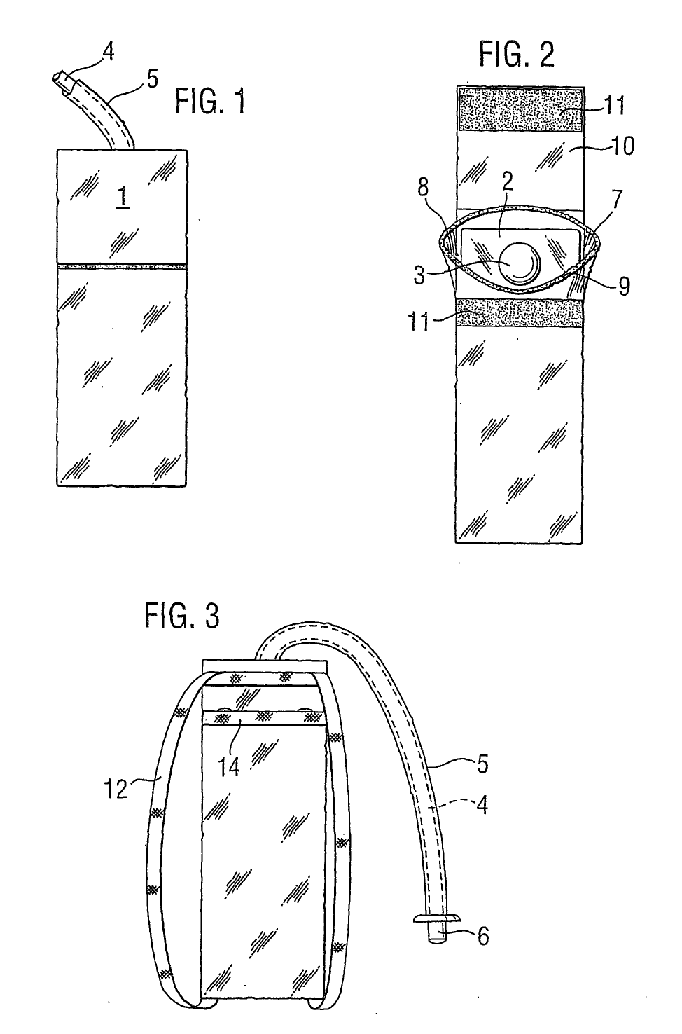

FIG. 1 is a front view of a drinking fluid carrier in accordance with the invention in its closed position;

FIG. 2 shows the carrier of FIG. 1 in its open position; and

FIG. 3 is a rear view of the carrier shown in FIGS. 1 and 2.

The illustrated carrier comprises a cover 1 produced from one or more sheets of chemically hardened material and an impermeable flexible drinking fluid container 2 (see FIG. 2). The container includes a conventional cap 3 which can be removed to enable the container to be filled with water or other drinking fluid. A drinking tube 4 (shown in broken line in FIGS. 1 and 3) projects Into the interior of the container. The container 2 is entirely housed within the cover 1 and the tube 4 passes through a conduit 5 which forms part of the cover 1 and is produced from the same chemically hardened material. An ON/OFF switch 6 is positioned within the tube 4 at its end remote from the cover.

The cover includes a pouch 7 for receiving the container 2. The open end of the pouch 7 is defined by a sleeve 8 which projects forwardly of the pouch. Strips 9 of sealing material (e.g. Velcro [RTM]) are positioned along the tips of the sleeve for sealing the pouch contents and interior from the atmosphere. A flap 10 is provided at the front of the cover 1. This flap is of a length which enables it to overlie the sleeve when closed to provide additional protection for the interior and contents of the cover. Strips of sealing material 11 (e.g. Velcro) are secured to the inner face of the flap 10 and the cover surface to secure the flap in place.

Shoulder straps 12 are secured to the rear of the cover to enable the carrier to be carried on the back of the user. An additional strap 14 is provided for supporting other pieces of equipment.

In use, the cover prevents any contamination of the drinking fluid present in the flexible container through exposure to chemical toxins in liquid or gaseous form, biological agents and radioactive particles which may be released into the atmosphere. Because of the cover, the suitably clad user can safely access the drinking fluid by sucking through an extension tube connected to the tube 4 and projecting through a side wall of a face mask worn by the user.

It will appreciated that the foregoing is merely exemplary of carriers in accordance with the invention and that modifications can readily be made thereto without departing from the true scope of the invention.

1. A portable flexible carrier for drinking fluid comprising a flexible fluid container entirely encased within an outer separable cover produced from a chemically hardened material which is impermeable to chemical toxins in liquid or gaseous form, biological agents and radioactive particles, a tube connected to an opening of the flexible container and extending beyond the confines of the cover interior through which drinking fluid can be removed by suction from the container, a conduit produced from the chemically hardened material within which the entire length of the tube is encased, an ON/OFF valve in communication with the tube to enable fluid to flow under suction from the carrier interior to the conduit, and means for selectively sealing the cover interior and its contents from the atmosphere.

2. A carrier as claimed in claim 1 wherein the chemically hardened material comprises a fabric support covered by a protective complex which acts as a barrier to chemical toxins in liquid or gaseous form, biological agents and radioactive particles.

3. A carrier as claimed in claim 1 including shoulder straps to enable it to be carried on the back of the user.

4. A carrier as claimed in claim 1 including a selectively sealable pouch and a sealable flap which is able to overlie the sealed end of the pouch.

5. A portable flexible carrier as herein described and as described with reference to the accompanying drawings.
